(19) United States
(12) Patent Application Publication
(10) Pub. No.: US 2002/0133326 A1
(43) Pub. Date: Sep. 19, 2002

(54) Methods, apparatus and computer program products for simulating plasma behavior in a plasma reactor apparatus using two-dimensional cross-section computations

(76) Inventors: Won-Young Chung, Kyungki-do (KR); Tai-Kyung Kim, Kyungki-do (KR); Jae-Joon Oh, Sungnam-city (KR)

Correspondence Address: MYERS BIGEL SIBLEY & SAJOVEC, PO BOX 37428, RALEIGH, NC, 27627, US

(21) Appl. No.: 09/995,421

(22) Filed: Nov. 27, 2001

(30) Foreign Application Priority Data
Jan. 3, 2001 (KR) 2001-167

(51) Int. Cl. G06G 7/54; G06F 17/50

(52) U.S. Cl. 703/18

(57) ABSTRACT

Characteristics of a plasma contained in a reaction chamber of a plasma reactor are determined by first computing plasma characteristics for each of a plurality of cross-sections of the reaction chamber, and then generating a generalized model of the plasma from the computed plasma characteristics for the plurality of cross-sections, for example, by averaging the computed plasma characteristics for the cross-sections. The plasma reactor may comprise a plurality of magnets that move with respect to the reaction chamber, such as in a dipole ring magnet (DRM) plasma reactor, and each of the plurality of cross-sections may include an axis of rotation about which the magnets rotate. Plasma characteristics for each the cross-sections of the reaction chamber may be computed by computing electron density and temperature using a Monte Carlo computational procedure and computing ion and neutral species transmission phenomena from a plasma dynamics simulation, e.g., by computing solutions to a continuity equation and Poisson's equation for the ion and neutral species. A static magnetic field generated by the moving magnets may be determined, and the plasma characteristics for each of the plurality of cross-sections may be from the determined static magnetic field, shape information for the reaction chamber, and plasma collision reaction data. The generalized model may be used, for example, to estimate an etching rate for a wafer positioned in the chamber.

### RELATED APPLICATION

This application is related to Korean Application No. 2001-167, filed Jan. 3, 2001, the disclosure of which is hereby incorporated herein by reference.

### BACKGROUND OF THE INVENTION

The present invention relates to methods, apparatus and computer program products for simulating plasma behavior in a plasma reactor apparatus, such as those widely used for manufacturing semiconductor devices.

In 1996, World Semiconductor Statistics (WSTS) showed that plasma-related equipment accounted for 40% of all semiconductor manufacturing equipment sales. Plasma processes are extensively used for deposition, ion implantation, cleaning, and etching. The use of plasma processes in manufacturing semiconductor devices is expected to increase.

Plasma etching processes used in manufacturing highly integrated semiconductor devices generally require precise control to meet requirements such as uniformity, selectivity ratio and anisotropy. Thus, setting up a mass production process using plasma etching techniques can be costly and time-consuming.

Such cost and time may be reduced by simulating plasma behavior. In particular, process development generally requires understanding of surface reaction and other phenomena associated with the plasma processing. Thus, plasma modeling and simulation can be valuable.

FIG. 1 is a flowchart of a conventional simulation method for inductively coupled plasma (ICP) equipment. Referring to FIG. 1, plasma reactor shape and process conditions (block 2) and data on plasma collision reaction (block 4) are provided. A plasma simulation (block 6) comprises three operations: a module that determines the electromagnetic field (block 8), a module that calculates electron density and temperature using a Monte Carlo technique (block 10), and a module that determines transmission phenomena of chemical species (block 12). These three operations are repeated until they converge to a result. This simulation results in estimates for plasma characteristics (block 14), such as electromagnetic field distribution, electron density and temperature, ion and neutral species distribution directly involved in surface reaction, and flux incident onto a wafer surface in a plasma reactor, all of which can affect etching processes. However, such simulations typically employ a three-dimensional calculation that can take several days or longer. Therefore, it may be impractical to apply such a simulation approach in the development of a real plasma process.

Plasma etching processes used in manufacturing semiconductor devices typically use dipole ring magnet (DRM) plasma equipment. Typical DRM plasma equipment implements a magnetically enhanced reactive ion etching (MERIE) method using a complex structure that includes several (e.g., 20) permanent magnets having different magnetic forces and fluxes that rotate around a plasma reaction chamber at speeds on the order of 20 revolutions per minute (rpm) (See “A New High-Density Plasma Etching System Using a Dipole-Ring Magnet”, JJAP, pp. 6274-6278, 1995).

A plasma having external magnetic fields applied thereto may be simulated using a conventional 3-dimensional calculation method (See “A three-dimensional model for inductively coupled plasma etching reactors: Azimuthal symmetry, coil properties, and comparison to experiments”, JAP, pp. 1337-1344, 1996). However, as discussed above, a conventional 3-dimensional simulation method may require a calculation time of several days or more. Therefore, it may be impractical to apply such a conventional 3-dimensional simulation method to the development of a real process using a structure such as that found in DRM plasma equipment.

### SUMMARY OF THE INVENTION

According to embodiments of the present invention, characteristics of a plasma contained in a reaction chamber of a plasma reactor are determined. Plasma characteristics for each of a plurality of cross-sections of the reaction chamber are first determined, and then a generalized model of the plasma is generated from the computed plasma characteristics for the plurality of cross-sections. For example, the plasma reactor may comprise a plurality of magnets that move with respect to the reaction chamber, such as in a dipole ring magnet (DRM) plasma reactor, and each of the plurality of cross-sections may include an axis of rotation about which the magnets rotate.

In some embodiments of the present invention, computing plasma characteristics for each of a plurality of cross-sections of the reaction chamber comprises computing electron density and temperature for a cross-section using an iterative Monte Carlo computational procedure and computing ion and neutral species transmission phenomena for the cross-section from a plasma dynamics simulation. Computing ion and neutral species transmission phenomena for the cross-section from a plasma dynamics simulation may comprise computing solutions to a continuity equation and Poisson's equation for the ion and neutral species. Prior to these computations, a static magnetic field generated by the moving magnets may be determined, and the computation of plasma characteristics for each of the plurality of cross-sections of the reaction chamber may comprise computing the plasma characteristics for each of the plurality of cross-sections from the determined static magnetic field, shape information for the reaction chamber, and plasma collision reaction data. Generating a generalized model of the plasma from the computed plasma characteristics for the plurality of cross-sections may comprise computing at least one of an electron density distribution, a temperature distribution, a distribution of ion species, a distribution of neutral species, and a flux incidence, e.g., by averaging the results of the computations performed for the two-dimensional cross-sections. The generalized model may be used, for example, to estimate an etching rate for a wafer positioned in the chamber.

The present invention may be embodied as methods, apparatus and computer program products.

### BRIEF DESCRIPTION OF THE DRAWINGS

FIG. 1 is a flowchart of a conventional simulation method for inductively coupled plasma (ICP) equipment.

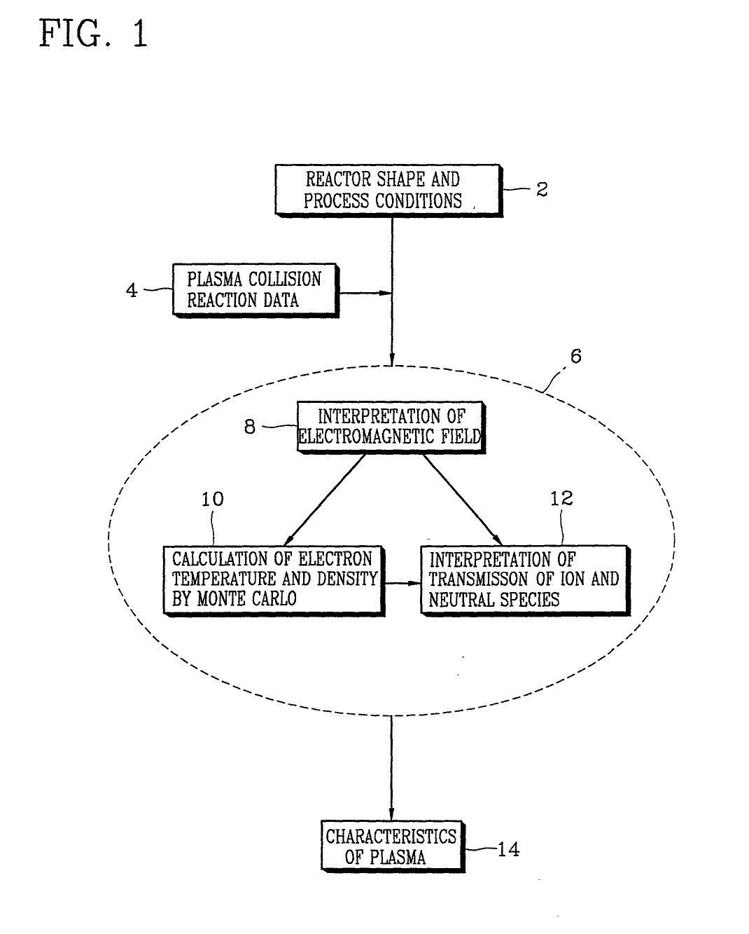

FIGS. 2 and 3 gare drawings illustrating a dipole ring magnet (DRM) plasma reactor apparatus.

FIGS. 4A and 4B are flowcharts illustrating apparatus and operations for simulating plasma behavior according to embodiments of the present invention.

FIG. 5 illustrates a magnetic field induced by magnets of a plasma reactor apparatus.

FIG. 6 is a graph illustrating simulated etch rate distributions for a silicon oxide layer obtained from a simulation according to embodiments of the present invention.

FIG. 7 is a graph comparing measured plasma density and simulated plasma density as generated by a plasma simulation according to embodiments of the present invention.

FIG. 8A is a graph illustrating an etch rate distribution for a silicon oxide layer as a function of etch gas composition ratio estimated according to embodiments of the present invention.

FIG. 8B is a graph illustrating an etch rate distribution for a silicon nitride layer as a function of etch gas composition ratio estimated according to embodiments of the present invention.

### DETAILED DESCRIPTION

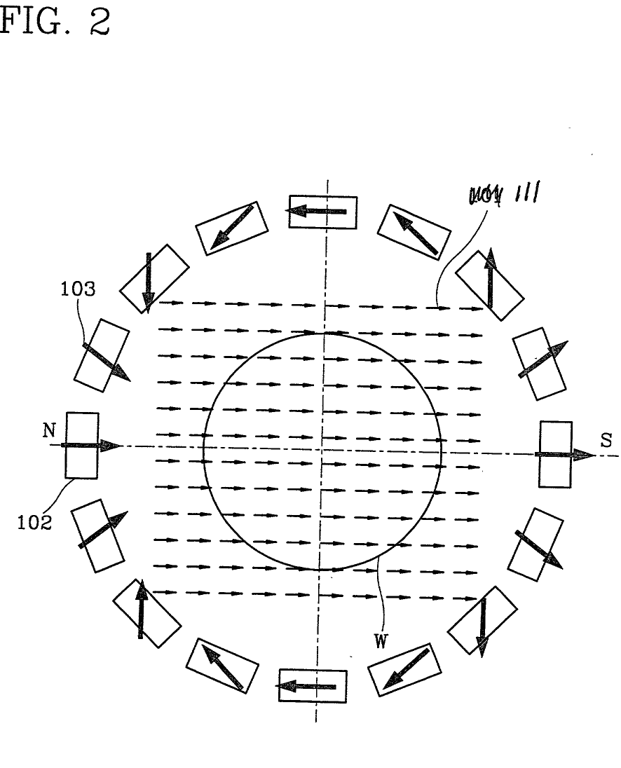

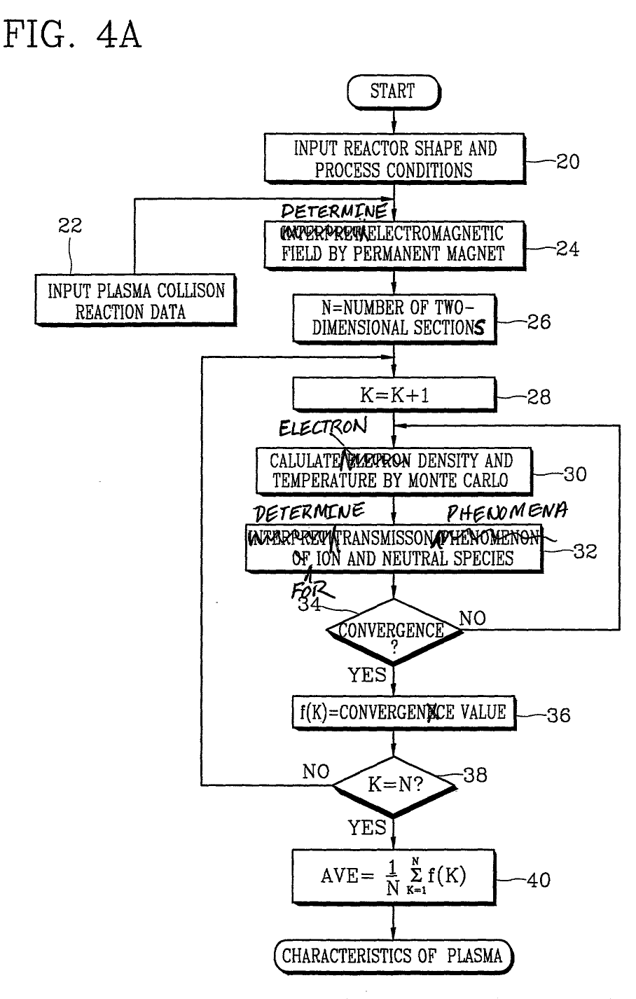

FIGS. 2 and 3 gare, respectively, a plane view showing the arrangement of permanent magnets in a DRM plasma apparatus and a cross-sectional view of a DRM plasma apparatus. Referring to FIGS. 2 and 3, a DRM plasma apparatus 100 implements a magnetically enhanced reactive ion etching (MERIE) method and has a structure including about 20 permanent magnets 102 having different magnetic forces and fluxes that rotate around a plasma reaction chamber 101. The permanent magnets 102 rotate around an axis of rotation 106. As shown in FIG. 2, magnetic fields 103 of the permanent magnets 102 are arranged in different directions, and form a composite magnetic field 111 in the reaction chamber 101. The permanent magnets 102 may be differently arranged depending on the type of equipment used. For example, in FIG. 2, the permanent magnets 102 are regularly spaced, while in FIG. 5, the permanent magnets 102 are irregularly spaced.

The permanent magnets 102 induce a magnetic field 111 that is approximately static, i.e., that is minimally affected by the state of a plasma 104 in the plasma reaction chamber 101. The time required for stabilizing the plasma 104 in the plasma reaction chamber 101 typically is on the order of hundreds of microseconds or less. A wafer W positioned in the plasma reaction chamber 100 is supported by a chuck C. An electrode 108 is connected to radio frequency power source 110.

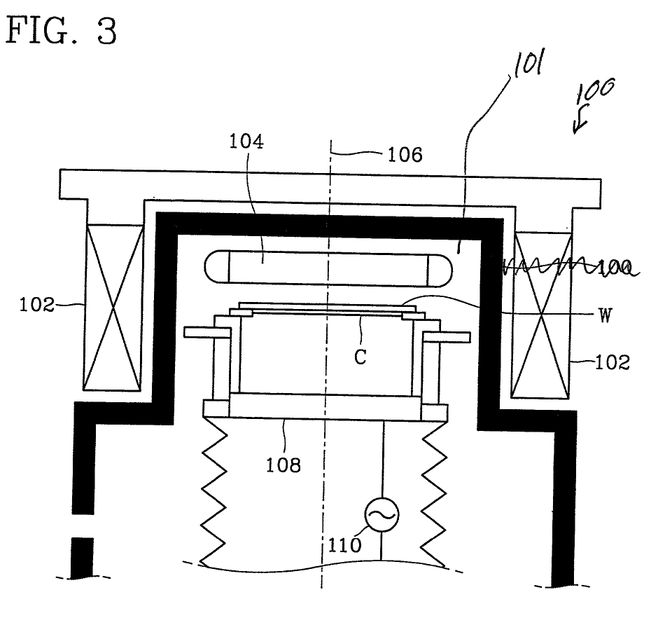

FIGS. 4A and 4B are flowchart illustrations of methods, apparatus (systems) and computer program products according to embodiments of the invention. It will be understood that each block of the flowchart illustrations, and combinations of blocks, can be implemented by computer program instructions. These computer program instructions may be provided to a processor of a general purpose computer, special purpose computer, or other programmable data processing apparatus, such as mainframe computer, high-performance computer workstation, or parallel-processing system, to produce a machine, such that the instructions, which execute via the processor of the computer or other programmable data processing apparatus, create structures for implementing the functions specified in the block diagram and/or flowchart block or blocks. These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagram and/or flowchart block or blocks. The computer program instructions may also be loaded onto a computer or other programmable data processing apparatus to cause a series of operational steps to be performed on the computer or other programmable apparatus to produce a computer implemented process or method such that the instructions which execute on the computer or other programmable apparatus provide steps for implementing the functions specified in the block diagram and/or flowchart block or blocks. Accordingly, the flowcharts of FIGS. 4A and 4B support methods, apparatus and computer program products for performing operations described therein.

In greater detail, FIGS. 4A and 4B illustrate operations and apparatus for simulating behavior of a plasma in a plasma reactor apparatus such as that illustrated in FIGS. 2 and 3. The configuration of the plasma reactor 100 and process conditions are input (block 20). In particular, shape information for the plasma reactor 100, such as the size of the plasma reaction chamber 101 and the position of the magnets 102, is input into a simulation program, along with process conditions such as power, pressure, and gas composition ratio. Plasma collision reaction data are also input into the simulation program (block 22). Plasma collision reaction data may include a reaction rate constant of the following collision reaction equation, and may be represented by a function such as electron temperature:

e^{—}Ar [symbol] Ar⁺+e^{—}+e^{—}

e^{—}Cl₂ [symbol] Cl+Cl+e^{—}

A 3-dimensional magnetic field induced by the permanent magnet 102 is computed using, for example, commercially-available software (block 24). For example, a commercial finite element analysis tool such as Vector Fields may be used to determine the 3-dimensional magnetic field. The magnetic field induced by the permanent magnet 102 is an approximately static magnetic field, which typically is minimally affected by the state of the plasma 104 gin the plasma reactor 100. Therefore, it is possible to calculate the magnetic field induced by the permanent magnet 102 apart from effects of the plasma 104.

Electron density and temperature are computed by a Monte Carlo method (block 30) and transmission phenomena of ion and neutral species (block 32) are determined until convergence is achieved (block 34). In FIG. 4A, electron density and temperature are first calculated by the Monte Carlo method and then the transmission phenomena of ion and neutral species are interpreted. As shown in FIG. 4B, determination of transmission phenomena of ion and neutral species (block 30′) may occur before calculation of electron density and temperature (block 32′).

The determination of electron density and temperature (blocks 32, 32′) and the determination of transmission phenomena of ion and neutral species (blocks 30, 30′) are performed for 2-dimensional cross-sections of the reaction chamber 101 in a characteristic magnetic field direction. In detail, convergence values (36) are obtained for each of a plurality of 2-dimensional cross-sections including the axis 106 of rotation.

The time required for stabilizing the plasma 104 for the given 2-dimensional static magnetic field distribution symmetrical to the axis is on the order of hundreds of microseconds (μs) or less. The permanent magnets 102 typically rotate around the plasma reaction chamber 101 at a speed of about 20rpm, which leads the magnetic field distribution to change depending on time. It is possible to 2-dimensionally sample the cross-sectional magnetic field distribution including the axis 106 in the characteristic magnetic filed direction. The time required for the simulation typically depends on the nature of the plasma 104 and the process conditions. For example, in the case of argon (Ar) plasma under typical process conditions, the simulation may take about one hour.

According to embodiments of the present invention, calculation of electron density and temperature by Monte Carlo simulation and determination of transmission phenomena of ion and neutral species are performed at a plurality of 2-dimensional cross-sections including an axis for cross-sectional magnetic field distribution in a characteristic magnetic field direction. The convergence values for the sections may be averaged to generate a generalized model of the plasma 104, for example, electron density and temperature in the plasma reaction chamber 101, the distribution of ion and neutral species involved in surface reaction at the wafer W, and flux incident onto a major surface of the wafer W.

Examples of methods for calculating electron density and temperature and of determining transmission phenomena of ion and neutral species will now be described. Collision probabilities of electron-ion, electron-neutral molecule/atom may be calculated and kept as a probability array. The collision frequency vᵢⱼ may be expressed as:

$${v}_{ij} = {( \frac{2 {ϵ}_{i}}{{m}_{e}} )}^{1 / 2} {σ}_{ij} {N}_{j} \qquad ( 1 )$$

where σᵢⱼ presents electron impact cross-section in I-energy and j-process and Nⱼ presents the density of collision partner in j-process. Ε_{I} and Mₑ denote energy and electron mass, respectively. As a result, a probability array Pᵢⱼ may be expressed by the formula:

$${P}_{ij} = [ {\sum }_{l = 1}^{j} {v}_{ij} + ( {v}_{m} - {v}_{i} ) ] / {v}_{m} \qquad ( 2 )$$

where vᵢ and vₘ are respectively expressed by formulas (3) and (4):

$${v}_{i} = {\sum }_{l = 1}^{l max} {v}_{il} \qquad ( 3 )$$

vₘ=max(vᵢ) (4)

where Iₘₐₓ represents the total number of processes.

The initial rate and position of an electron, respectively, may be extracted from a Maxwell distribution and a random distribution, and the trajectory of respective pseudo electrons may be separately tracked. A time step Δtl for determination of particle motion may be expressed by formula (5):

Δtₗ=min(00.1τ_{rf}, 00.1τ_{ECR}, t_{cl}−tₗ) (5)

where τₗ is the time until the trajectory of particle l is updated, τ_{rf} is the radio frequency period, τ_{ECR} is the local electron cyclotron period, and t_{ct} is the time until next collision, namely, t_{ct}=tₜₒ+Vₘ⁻¹1n(R), RΕ[0,1] (where t_{lO} represents the initial time). A specific process is also selected among several possible processes using a random number generator.

This Monte Carlo iteration continues for about 20-50 RF cycles (about 3 μs), and an electron impact source function is obtained from a time-averaged electron energy distribution function f (Ε, r, and z) and formula (6):

$${S}_{ij} = {n}_{e} ( r , z ) {δ}_{ij} {N}_{ij} ( r , z ) \times {\int }_{0}^{∞} f ( ϵ , r , z ) ( \frac{{2}_{ϵ}}{{m}_{e}} ) {σ}_{ij} ( ϵ ) ⅆ ϵ \qquad ( 6 )$$

where nₑ and Nᵢⱼ respectively represent electron density and collision partner density in I-energy and j-process calculated from a transmission phenomenon interpretation module just before repeating, and τ represents energy. Also, if process ij is a source of j species, δᵢⱼ is +1, gand if process ij is a loss, δᵢⱼ is −1.

The transmission phenomena determination may involve solving a continuity equation and Poisson's equation for all ion and neutral species, as expressed by formulas (7) and (8):

$$\begin{matrix}\frac{δ {N}_{j}}{δ t} = ∇ ( {μ}_{j} {q}_{j} {N}_{j} {\vec{E}}_{s} - {D}_{j} ∇ {N}_{j} ) + {( \frac{δ {N}_{j}}{δ t} )}_{c} & ( 7 ) \\ ∇ \cdot {\vec{E}}_{s} = - {∇}^{2} Φ = \frac{ρ}{{ϵ}_{0}} & ( 8 )\end{matrix}$$

where μⱼ, Dⱼ, qⱼ, p, (δNⱼ/δt)_{c}, Eₛ, Φ, and Ε_{O}, are the mobility of j-species, diffusion coefficient of j-species, charge of j-species, charge density, density variation by all collisions, electric field, electrostatic potential, and dielectric constant of a vacuum state, respectively. (δNⱼ/δt)_{c} includes contribution by heavy particles as well as contribution from Sⱼ (generation rate in coordinates r and z), which are not distinguished in Formulas (7) and (8).

The continuity equation may exhibit a problem where the Knudsen number λ/L (λ is an averaged free path and L is the length of a reactor) is increased to greater than 0.1 with less than 100 mTorr pressure, diffusion velocity may get faster than the thermal velocity (Vₜₕ) of respective species during drift-diffusion. Consequently, to prevent this phenomenon, diffusion coefficient and particle mobility may limited, as expressed by formulas (9) and (10):

Dⱼ=min(VₜₕL, Dⱼ) (9)

$${μ}_{j} = \frac{{eD}_{j}}{{kT}_{j}} \qquad ( 10 )$$

where e, k, and Tⱼ are the charge of the electron, Boltzman's constant, and the temperature of j species, respectively.

A general plasma dynamics simulation may separately solve Poisson's equation and the continuity equation. However, when the general plasma dynamics simulation solves these equations simultaneously, it may exhibit a time-step problem. In a case where a transport equation is obtained from explicit differencing, time-step may be limited by a courant limit, as expressed by formula (11):

$$Δ {t}_{c} \leq min ( \frac{Δ r}{{μ}_{j} {E}_{r}} , \frac{Δ z}{{μ}_{j} {E}_{z}} ) \qquad ( 11 )$$

where Δr and Δz represent spacial mesh sizes, Eᵣ represents an electromagnetic field in a r direction, and E_{z} represents an electromagnetic field in a z direction. In the case of obtaining an implicit solution, the time-step may be theoretically much larger than the courant limit. However, Poisson's equation is typically solved by an explicit method regardless of the transport equation. This is why charge density in the current step may be required for updating a potential in a subsequent step, as shown in formula (12):

$${∇}^{2} Φ ( t + Δ t ) = - \frac{ρ ( t )}{{ϵ}_{0}} \qquad ( 12 )$$

In this case, the maximum time-step is shorter than a dielectric relaxation time so that the electromagnetic field changes the sign of the time-step, as expressed by formula (13):

$$Δ {t}_{d} = \frac{{ϵ}_{0}}{σ} \qquad ( 13 )$$

where σ represents plasma conductivity. Estimating a dielectric relaxation time value from some calculations, in the case of plasma with low pressure and high density, σ is about 0.1˜1 (Ωcm)⁻¹. Therefore, Δt_{d}, which is about 10⁻¹³˜10⁻¹² seconds, is much shorter than the courant limit.

To solve such a short-time-step problem, a semi-implicit differencing type technique may be used in determining transmission phenomena, as expressed by formula (14):

$${∇}^{2} Φ ( t + Δ t ) = - \frac{1}{{ϵ}_{0}} [ ρ ( t ) + Δ t \frac{ⅆ ρ ( t )}{ⅆ t} ] \qquad ( 14 )$$

where a time-derivative of charge density includes only a transport term. The final equation to be solved for which the transport term of formula (7) is expressed by formula (15):

$${∇}^{2} Φ ( t + Δ t ) + \frac{1}{{ϵ}_{0}} Δ t {\sum }_{i} e {q}_{i} {μ}_{i} \times [ ∇ {N}_{i} ∇ Φ ( t + Δ t ) + {N}_{i} {∇}^{2} Φ ( t + Δ t ) ] = - \frac{ρ ( t )}{{ϵ}_{0}} - \frac{1}{{ϵ}_{0}} Δ t e {\sum }_{i} {q}_{i} ( ∇ {D}_{i} ∇ {N}_{i} ) \qquad ( 15 )$$

The formula (15) may be solved by a succession of relaxation (SOR) method, where the optimized SOR parameter is 1.8≦α≦1.9. According to the above semi-implicit technique, the time-step may be about 100˜1000 times lager than Δtd or as large as the courant limit.

Some have reported that, in the case where the time-step gets larger by the above method, the difference in accuracy is mostly within a few percentage points. However, it has been confirmed that plasma potential and plasma density are about 30% different from an absolute value.

In solving Poisson's equation, boundary conditions may depend on whether the surface of a reactor or a substrate is metal or dielectric. In the case where the surface is metal, the surface is grounded or is determined by an external potential. In the case where the surface is a dielectric, potential 40 of the portion in contact with plasma is expressed by formula (16):

$${Φ}_{0} = \frac{[ {Φ}_{l} + Δ z [ {σ}_{s} / {ϵ}_{0} + {ϵ}_{d} {Φ}_{b} / ( {ϵ}_{0} L ) ]}{1 + Δ z {ϵ}_{d} / ( {ϵ}_{0} L )} \qquad ( 16 )$$

where Φₗ represents the plasma potential at the first mesh on the surface, E_{d} represents permissivity of the dielectric, L represents the thickness of dielectric, and Φ_{b} represents plasma potential opposite to the surface. σₛ represents surface charge density, as obtained from formula (17):

$${σ}_{s} = {\sum }_{j} \int e {q}_{j} {∅}_{j} ⅆ t \qquad ( 17 )$$

where ∅ⱼ=(qⱼ, uⱼNⱼ\vec{E}−Dⱼ∇Nⱼ)·\hat{n} represents flux which reaches the surface.

Convergence velocity generally depends on how close the initial guess for species density approaches an actual value. The time for convergence is typically about 10˜100 μs. Thus, in the case of a low initial guess value, a substantial amount of calculation time may be required. For example, in a case where the time-step is 1 ns (10⁻⁹ s), the time-step may require 10⁵ cycles to approach up to 100 μs. Also, 0.025 seconds are typically required per cycle when processed using a Silicon Graphics® Onyx® workstation. Thus, it may take 7 hours to determine just the transmission phemonema.

To reduce such computation time, an acceleration technique that improves the initial guess using prior results before determination of transmission phenomena may be used. Such an acceleration technique scales up or scales down dN/dt calculated by the initial time-step of about 1·100 ns to about 1000·2000 times to increase the effective time-step to 1000·2000 times, as expressed by formula (18):

$${N}_{j} ( r , z , t + Δ t ) = {N}_{j} ( r , z , t ) + γ ( \frac{ⅆ {N}_{j}}{ⅆ t} ) Δ t \qquad ( 18 )$$

That is, the parameter Υ for determining acceleration is increased to about 1000·2000, which increases the effective time-step. In this case, converged results may be obtained in about 100·1000 cycles (the maximum number of cycles is generally about 500 in the input step). The density of negatively-charged species may be re-normalized to be equal to the sum of negatively-charge species and positively-charged species, which can solve the charge neutrality problem.

FIG. 5 shows an electromagnetic field distribution on a wafer W induced by a permanent magnet. The magnetic field is formed on the wafer W in the plasma reactor 100 by the permanent magnets 102 which are asymmetrically arranged and rotate around the plasma reaction chamber 101. The magnetic field is a substantially static magnetic field, magnetic flux density of which varies with location on the wafer. For example, on the wafer, magnetic flux density at the point A is about 180 Gauss, the magnetic flux density at the point B is about 120 Gauss, and the magnetic flux density at the point C is about 60 Gauss. According to embodiments of the invention described above, a 2-dimensional plasma simulation is performed for cross-sectional magnetic field distribution in characteristic magnetic field directions, for example, directions I, II, and III. From these results, a generalized plasma behavior model can be generated.

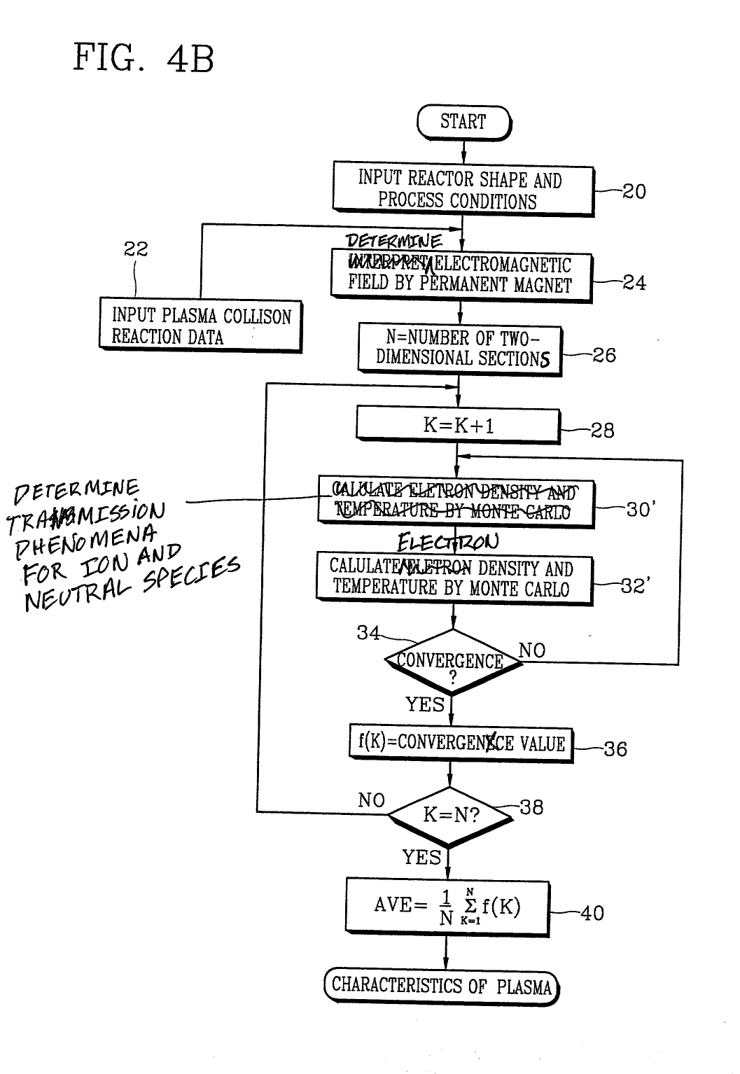

FIG. 6 is a graph illustrating an etch rate distribution of a silicon oxide (SiO₂) layer calculated according to embodiments of the present invention, for cross-sectional magnetic field distributions comprising 3 sections and 8 sections, respectively. The 2-dimensional plasma simulation was performed assuming a pressure of 25 mTorr, a RF power of 1200 W, CHF₃ flux of 150 sccm, CO flux of 50 sccm, and O₂ flux of 10 sccm. The location on the wafer denotes the distance from the center of the wafer.

As shown in FIG. 6, the calculated etch rate of the silicon oxide layer at the wafer center is about 1600 Å/min for both the simulation using 3 cross-sections and the simulation using 8 cross-sections. Etch rates of the silicon oxide layer at about 6 cm point from the wafer center are about 1800 Å/min for the simulation at 3 sections and about 1750 Å/min for the simulation value at 8 sections.

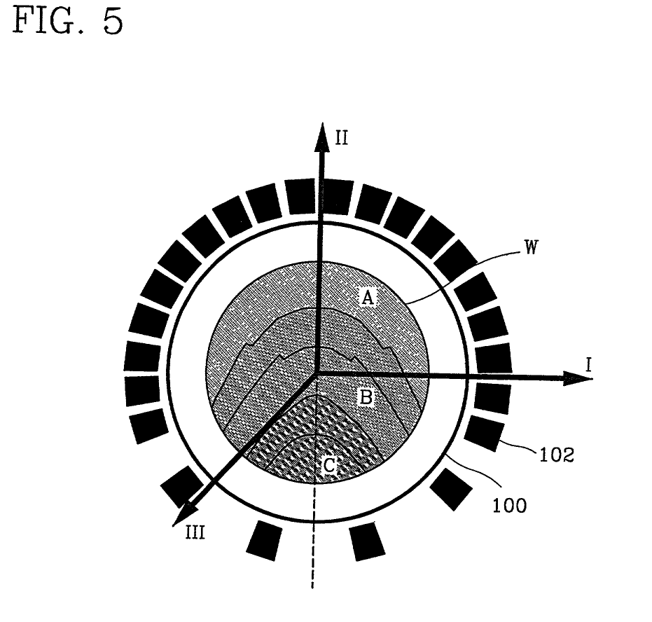

FIG. 7 is a graph illustrating actual measured plasma density as a function of power and plasma density obtained from a plasma simulation according to embodiments of the present invention using 3 two-dimensional cross-sections. Here, argon (Ar) plasma is used, Ar flux is 200 sccm and pressure is 40 mTorr. As can be seen in FIG. 7, there is close agreement of the measured values and the calculated values from the simulation.

Table 1 shows simulated and measured values for etch rates of a silicon oxide (SiO₂) layer and a silicon nitride (Si₃N₄) layer for various in process conditions. Simulations and experiments were performed for the SiO₂ layer and the Si₃N₄ layers using a varying etch gas composition ratio and power at a pressure of 35 mTorr.

TABLE 1

| | Etch Rate (Å/min) | | | | | |
|---|---|---|---|---|---|---|
| | SiO₂ | | | Si₃N₄ | | |
| Process Conditions | Calculation | Experimental | | Calculation | Experimental | |
| (Power/CHF₃(sccm)/ | Value | Value | Errors | Value | Value | Errors |
| CO(sccm)/O₂(sccm) | (Å/min) | (Å/min) | (%) | (Å/min) | (Å/min) | (%) |
| 1500 W/31/150/10 | 217 | 2019 | 4.87 | 1850 | 1838 | 0.78 |
| 1500 W/35/150/6 | 2454 | 2560 | −4.18 | 2133 | 2036 | 4.72 |
| 1500 W/39/150/2 | 2755 | 2737 | 0.65 | 2362 | 2262 | 4.39 |
| 1200 W/35/150/6 | 2156 | 2294 | −6.02 | 1846 | 1924 | −4.04 |
| 1800 W/35/15O/6 | 2665 | 2726 | −2.23 | 2314 | 2191 | 5.60 |

As demonstrated in Table 1, the etch rate increases with the fraction of CHF₃, which is due to the increase in the entire flux and radical flux. An increase in power appears to cause the etch rate to increase. As shown in Table 1, the simulated etch rates of both silicon oxide and silicon nitride layers show good agreement with experimental data, with less than a 6% error.

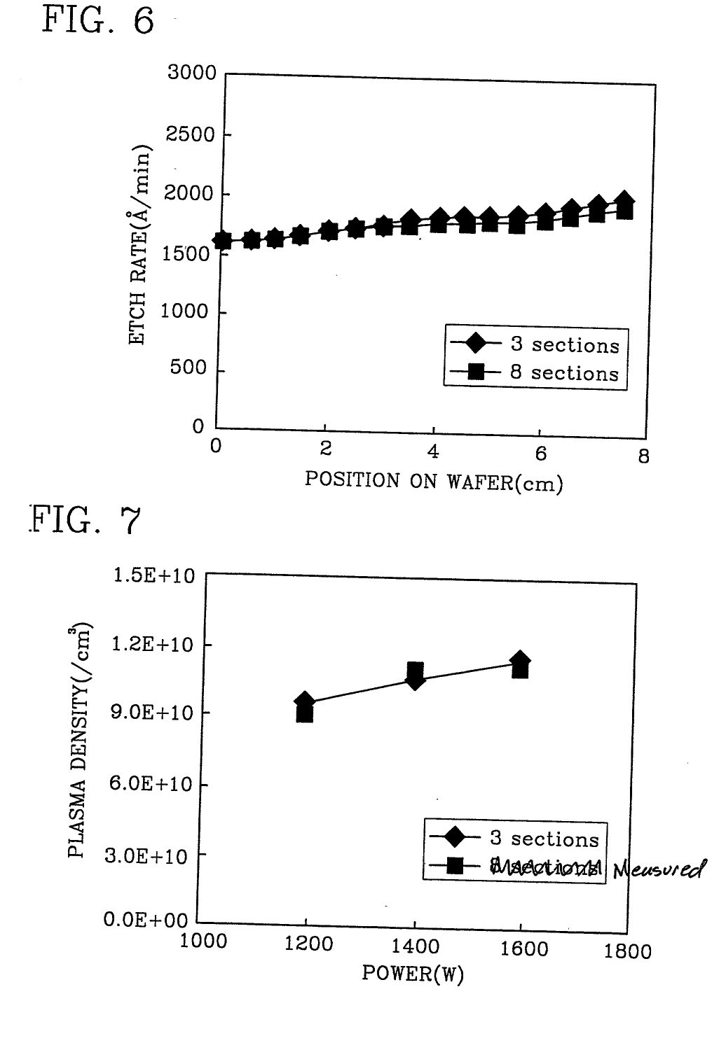

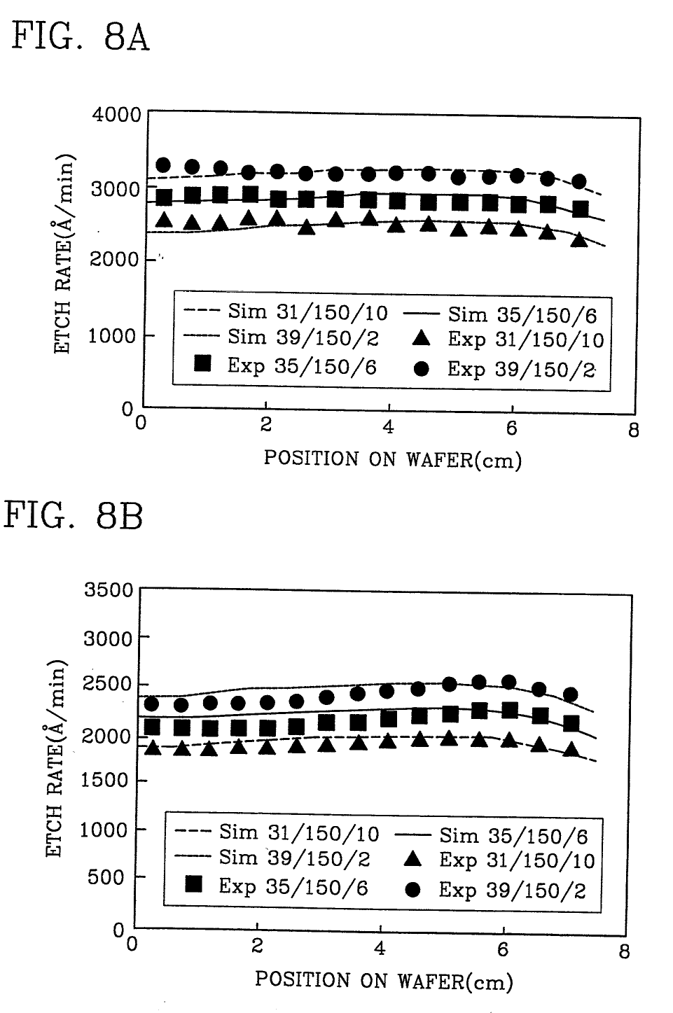

FIG. 8A and 8B are graphs illustrating etch rate distribution of silicon oxide and silicon nitride layers for varying etch gas composition ratio. FIGS. 8A and 8B denote etch rate distributions of the silicon oxide and silicon nitride layers, respectively, with ‘Sim’ denoting calculated values obtained from simulation and ‘Exp’ denoting experimental values obtained by measurement of an actual process. Gas composition ratio terms 31/150/10 are CHF₃ flux (sccm)/CO flux (sccm)/O₂ flux (sccm), respectively. Position on the wafer means the distance from the wafer center. In the case of the silicon oxide layer, the calculated value obtained from simulation at the wafer edge is lower than the experimental value obtained from the actual process. However, simulated etch rates show less than a 6% error. In the case of the silicon nitride layer, the etch rate increases toward the wafer edge, has a maximum value at a predetermined position, and decreases at the edge. Simulated etch rates also show less than a 6% error.

According to embodiments of the present invention, plasma behavior is simulated using calculations for 2-dimensional cross-sections including an axis of magnet rotation in a characteristic magnetic field direction. As a result, the time needed for simulation can be substantially reduced and the plasma characteristics can be precisely estimated. For example, plasma simulation for a DRM plasma reactor may be performed in a relatively short time, for example, within about 1˜2 hours. The plasma characteristics, such as plasma density and temperature, density distributions of respective chemical species, and flux distribution incident onto the wafer, can be precisely estimated. Based on the plasma characteristics, etch and deposition rates can be estimated. The method, apparatus and computer program products of the present invention can be effectively used for process development and process optimization.

That which is claimed is:

1. A method of estimating characteristics of a plasma contained in a reaction chamber of a plasma reactor including a plurality of magnets that move with respect to the reaction chamber, the method comprising:
computing plasma characteristics for each of a plurality of cross-sections of the reaction chamber; and
generating a generalized model of the plasma from the computed plasma characteristics for the plurality of cross-sections.

2. A method according to claim 1, wherein the plurality of moving magnets rotate about an axis of rotation, and wherein each of the plurality of cross-sections includes the axis of rotation.

3. A method according to claim 1, wherein computing plasma characteristics for each of a plurality of cross-sections of the reaction chamber comprises performing the following actions for each of the cross-sections:
computing electron density and temperature for the cross-section using an iterative Monte Carlo computational procedure; and
computing ion and neutral species transmission phenomena for the cross-section from a plasma dynamics simulation.

4. A method according to claim 3, wherein computing the ion and neutral species transmission phenomena for the cross-section from a plasma dynamics simulation comprises computing solutions to a continuity equation and Poisson's equation for the ion and neutral species.

5. A method according to claim 3, further comprising determining a static magnetic field generated by the moving magnets, and wherein computing plasma characteristics for each of a plurality of cross-sections of the reaction chamber comprises computing the plasma characteristics for each of the plurality of cross-sections from the determined static magnetic field, shape information for the reaction chamber, and plasma collision reaction data.

6. A method according to claim 1, wherein generating a generalized model of the plasma from the computed plasma characteristics for the plurality of cross-sections comprises computing at least one of an electron density distribution, a temperature distribution, a distribution of ion species, a distribution of neutral species, and a flux incidence.

7. A method according to claim 1, wherein generating a generalized model of the plasma from the computed plasma characteristics for the plurality of cross-sections comprises averaging the computed plasma characteristics for each of the plurality of cross-sections.

8. A method according to claim 1, further comprising estimating an etching rate for a wafer positioned in the chamber from the generalized model of the plasma.

9. A method according to claim 1, wherein the plasma reactor comprises a dipole ring magnet (DRM) plasma reactor.

10. An apparatus for estimating characteristics of a plasma contained in a reaction chamber of a plasma reactor including a plurality of magnets that move with respect to the reaction chamber, the apparatus comprising:
means for computing plasma characteristics for each of a plurality of cross-sections of the reaction chamber; and
means for generating a generalized model of the plasma from the computed plasma characteristics for the plurality of cross-sections.

11. An apparatus according to claim 10, wherein the plurality of moving magnets rotate about an axis of rotation, and wherein each of the plurality of cross-sections includes the axis of rotation.

12. An apparatus according to claim 10, wherein the means for computing plasma characteristics for each of a plurality of cross-sections of the reaction chamber comprises:
means for computing electron density and temperature for a cross-section using an iterative Monte Carlo computational procedure; and
means for computing ion and neutral species transmission phenomena for the cross-section from a plasma dynamics simulation.

13. An apparatus according to claim 12, wherein the means for computing the ion and neutral species transmission phenomena for the cross-section from a plasma dynamics simulation comprises means for computing solutions to a continuity equation and Poisson's equation for the ion and neutral species.

14. An apparatus according to claim 12, further comprising means for determining a static magnetic field generated by the moving magnets, and wherein computing plasma characteristics for each of a plurality of cross-sections of the reaction chamber comprises computing the plasma characteristics for each of the plurality of cross-sections from the determined static magnetic field, shape information for the reaction chamber, and plasma collision reaction data.

15. An apparatus according to claim 10, wherein the means for generating a generalized model of the plasma from the computed plasma characteristics for the plurality of cross-sections comprises means for computing at least one of an electron density distribution, a temperature distribution, a distribution of ion species, a distribution of neutral species, and a flux incidence.

16. An apparatus according to claim 10, wherein the means for generating a generalized model of the plasma from the computed plasma characteristics for the plurality of cross-sections comprises means for averaging the computed plasma characteristics for each of the plurality of cross-sections.

17. An apparatus according to claim 10, further comprising means for estimating an etching rate for a wafer positioned in the chamber from the generalized model of the plasma.

18. An apparatus according to claim 10, wherein the plasma reactor comprises a dipole ring magnet (DRM) plasma reactor.

19. A computer program product for estimating characteristics of a plasma contained in a reaction chamber of a plasma reactor including a plurality of magnets that move with respect to the reaction chamber, the computer program product comprising program code embodied in a computer-readable storage medium, the program code comprising:
program code for computing plasma characteristics for each of a plurality of cross-sections of the reaction chamber; and
program code for generating a generalized model of the plasma from the computed plasma characteristics for the plurality of cross-sections.

20. A computer program product according to claim 19, wherein the plurality of moving magnets rotate about an axis of rotation, and wherein each of the plurality of cross-sections includes the axis of rotation.

21. A computer program product according to claim 19, wherein the program code for computing plasma characteristics for each of a plurality of cross-sections of the reaction chamber comprises:
program code for computing electron density and temperature for a cross-section using an iterative Monte Carlo computational procedure; and
program code for computing ion and neutral species transmission phenomena for the cross-section from a plasma dynamics simulation.

22. A computer program product according to claim 21, wherein the program code for computing the ion and neutral species transmission phenomena for the cross-section from a plasma dynamics simulation comprises program code for computing solutions to a continuity equation and Poisson's equation for the ion and neutral species.

23. A computer program product according to claim 21, further comprising program code for determining a static magnetic field generated by the moving magnets, and wherein the program code for computing plasma characteristics for each of a plurality of cross-sections of the reaction chamber comprises program code for computing the plasma characteristics for each of the plurality of cross-sections from the determined static magnetic field, shape information for the reaction chamber, and plasma collision reaction data.

24. A computer program product according to claim 19, wherein the program code for generating a generalized model of the plasma from the computed plasma characteristics for the plurality of cross-sections comprises program code for computing at least one of an electron density distribution, a temperature distribution, a distribution of ion species, a distribution of neutral species, and a flux incidence.

25. A computer program product according to claim 19, wherein the program code for generating a generalized model of the plasma from the computed plasma characteristics for the plurality of cross-sections comprises program code for averaging the computed plasma characteristics for each of the plurality of cross-sections.

26. A computer program product according to claim 19, further comprising program code for estimating an etching rate for a wafer positioned in the chamber from the generalized model of the plasma.

27. A computer program product according to claim 19, wherein the plasma reactor comprises a dipole ring magnet (DRM) plasma reactor.

28. A method of simulating plasma in a plasma apparatus having a plasma reactor and a plurality of permanent magnets which are asymmetrically arranged and rotate around the plasma reactor at predetermined speed, comprising the steps of:
(a) inputting a plasma reactor shape and process conditions and inputting plasma collision reaction data;
(b) 3-dimensionally computing static magnetic fields induced by the permanent magnets;
(c) computing electron density and temperature by a Monte Carlo method and interpreting the transmission phenomenon of ion and neutral species using the data of the steps (a) and (b) until they are converged; and
(d) obtaining overall plasma characteristics using the converged values.

29. The method of claim 28, wherein the step c) comprises plasma simulation at 2-dimensional cross-sections for cross-sectional magnetic field distribution in a characteristic magnetic field direction.

30. The method of claim 29, wherein the 2-dimensional plasma simulation is performed for a plurality of 2-dimensional cross-sections including an axis, obtains convergence values for the respective cross-sections, and averages them to obtain plasma characteristics.

31. The method of claim 28, wherein the plasma apparatus is a DRM plasma apparatus.

32. Computer readable recording media for recording a simulation method of plasma processing by a plasma apparatus having a plasm reactor and a plurality of permanent magnets which are asymmetrically arranged and rotate around the plasma reactor at a predetermined speed, comprising:
(a) a program module for inputting the plasma reactor shape and process conditions;
(b) a program module for inputting plasma collision reaction data;
(c) a program module for 3-dimensionally computing static magnetic fields induced by the permanent magnets; and
(d) a program module for calculating electron density and temperature by a Monte Carlo method and interpreting the transmission phenomenon of ion and neutral species until they are converged.

33. The computer readable recording media of claim 32, wherein the program module (d) comprises plasma simulation at 2-dimensional cross-sections for cross-sectional magnetic field distribution in a characteristic magnetic field direction.

34. The computer readable recording media of claim 33, wherein the 2-dimensional plasma simulation is performed for a plurality of 2-dimensional cross-sections including an axis, obtains convergence values for the respective cross-sections, and averages them to obtain plasma characteristics.

35. The computer readable recording media of claim 32, wherein the plasma apparatus is a DRM plasma apparatus.
